(19) United States
(12) Patent Application Publication
(10) Pub. No.: US 2020/0362980 A1
(43) Pub. Date: Nov. 19, 2020

(54) CURRENT CONTROLLER AND HYDRAULIC SYSTEM

(71) Applicant: DENSO CORPORATION, Kariya-city (JP)

(72) Inventors: Fuminori SUZUKI, Kariya-city (JP); Kazuhiro SASAO, Kariya-city (JP)

(21) Appl. No.: 16/938,439

(22) Filed: Jul. 24, 2020

Related U.S. Application Data
(63) Continuation of application No. PCT/JP2019/001141, filed on Jan. 16, 2019.

(30) Foreign Application Priority Data
Jan. 31, 2018 (JP) 2018-015447

(51) Int. Cl. F16K 31/06

(52) U.S. Cl. CPC F16K 31/06

(57) ABSTRACT

A current controller for controlling a current of a solenoid includes a drive unit configured to energize the solenoid with a predetermined energization period according to a drive signal, a signal output unit configured to generate and output the drive signal based on a target current for the solenoid, and a target setting unit that applies a dither amplitude to the target current such that the target current changes periodically with a dither period longer than the energization period. The target setting unit is configured to set the target current according to a positional relationship between a hydraulic pressure gentle curve region of the solenoid and a target stroke of the valve element corresponding to a target output hydraulic pressure.

### CROSS REFERENCE TO RELATED APPLICATIONS

The present application is a continuation application of International Patent Application No. PCT/JP2019/001141 filed on Jan. 16, 2019, which designated the U.S. and claims the benefit of priority from Japanese Patent Application No. 2018-15447 filed on Jan. 31, 2018, the disclosure of both of which is incorporated herein by reference.

### TECHNICAL FIELD

The present disclosure relates to a current controller.

### BACKGROUND

A solenoid valve typically includes a solenoid which operates a valve element. A current controller may be provided to control the solenoid of the solenoid valve by regulating the amount of current applied to the solenoid.

### SUMMARY

According to the present disclosure, a current controller is for controlling a current of a solenoid. The current controller is applied to a solenoid valve that has a self-regulating pressure function due to a feedback force from output hydraulic pressure and which has a characteristic that includes a hydraulic pressure steep curve region and a hydraulic pressure gentle curve region, a degree of change in the output hydraulic pressure with respect to a change in stroke of a valve body being relatively steep in the hydraulic pressure steep curve region and relatively gentle in the hydraulic pressure gentle curve region.

The current controller includes a drive unit configured to energize the solenoid with a predetermined energization period according to a drive signal, a signal output unit configured to generate and output the drive signal based on a target current for the solenoid; and a target setting unit that applies a dither amplitude to the target current such that the target current changes periodically with a dither period longer than the energization period, wherein a target stroke is defined as the stroke of the valve element corresponding to a target output hydraulic pressure, and the target setting unit is configured to set the target current according to a positional relationship between the target stroke and the hydraulic pressure gentle curve region.

### BRIEF DESCRIPTION OF DRAWINGS

The above and other objects, features and advantages of the present disclosure will become more apparent from the following detailed description made with reference to the accompanying drawings. In the drawings:

FIG. 1 is a schematic diagram showing an automatic transmission to which a current controller is applied.

FIG. 2 is a cross sectional view of a solenoid valve.

FIG. 3 is a characteristic diagram showing the relationship between the strokes of the solenoid valve spool and the output hydraulic pressure.

FIG. 4 is an enlarged view of a main part of the solenoid valve, showing a state where the stroke is in a first hydraulic pressure steep curve region of FIG. 3.

FIG. 5 is a cross sectional view taken along line V-V of FIG. 4.

FIG. 6 is an enlarged view of a main part of the solenoid valve, showing a state where the stroke is in a hydraulic pressure gentle curve region of FIG. 3.

FIG. 7 is a cross sectional view taken along line VII-VII of FIG. 6.

FIG. 8 is an enlarged view of a main part of the solenoid valve, showing a state where the stroke is in a second hydraulic pressure steep curve region of FIG. 3.

FIG. 9 is a cross sectional view taken along line IX-IX of FIG. 8.

FIG. 10 is a block diagram illustrating functional units of a current controller.

FIG. 11 is a time chart diagram for explaining current controls executed by the current controller.

FIG. 12 is a stroke-output hydraulic pressure characteristic diagram for explaining a procedure in which the current controller calculates an evaluation value.

FIG. 13 is a current-output hydraulic pressure characteristic diagram illustrating a procedure of calculating an evaluation value by a current controller.

FIG. 14 is a time chart diagram showing a force balanced state of the spool when the current controller executes current control.

FIG. 15 is a flowchart illustrating a process executed by the current controller.

FIG. 16 is a time chart diagram showing a balanced state of current, stroke, output hydraulic pressure, and force when the current controller executes current control.

FIG. 17 is a block diagram illustrating functional units of the current controller.

FIG. 18 is a time chart diagram showing a force balanced state of the spool when the current controller executes current control.

FIG. 19 is a flowchart illustrating a process executed by the current controller.

FIG. 20 is a time chart diagram showing a balanced state of current, stroke, output hydraulic pressure, and force when the current controller executes current control.

FIG. 21 is a block diagram illustrating functional units of the current controller.

FIG. 22 is a time chart diagram showing a force balanced state of the spool when the current controller executes current control.

FIG. 23 is a flowchart illustrating a process executed by the current controller.

FIG. 24 is a time chart diagram for explaining the mechanism behind the occurrence of self-induced oscillation of a spool with respect to a comparative example.

FIG. 25 is a time chart diagram showing a balanced state of current, stroke, output hydraulic pressure, and force when current control is executed in the comparative example.

### DETAILED DESCRIPTION

Hereinafter, multiple embodiments will be described with reference to the drawings. In the embodiments, components which are substantially similar to each other are denoted by the same reference numerals and redundant description thereof is omitted.

### First Embodiment

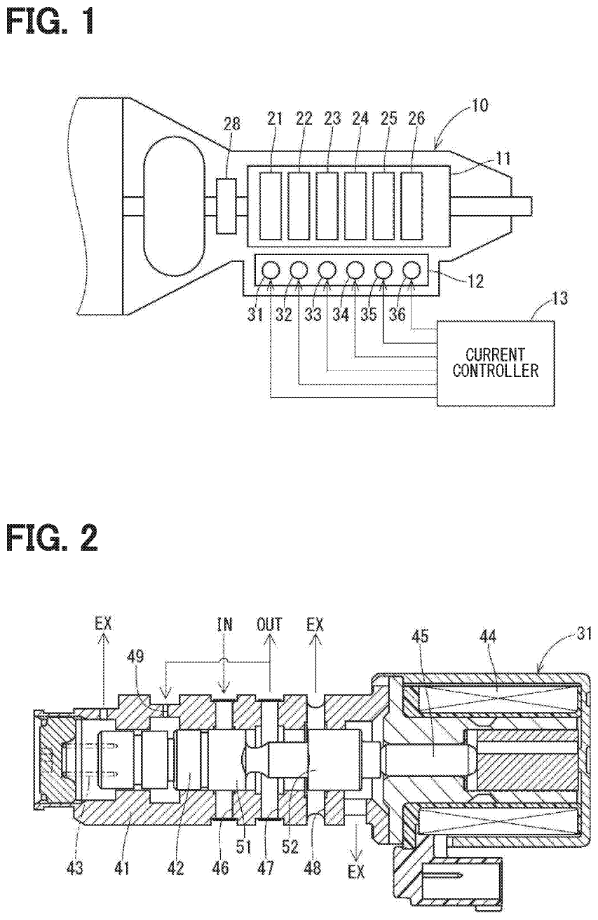

A current controller according to a first embodiment is applied to an automatic transmission shown in FIG. 1. First, an automatic transmission 10 will be described. An automatic transmission 10 includes a transmission mechanism 11, a hydraulic circuit 12, and a current controller 13. The transmission mechanism 11 has multiple friction elements 21 to 26 including, for example, a clutch, a brake, and the like, and a transmission ratio of the transmission mechanism 11 is variable stepwise by selectively engaging the friction elements 21 to 26. The hydraulic circuit 12 has a plurality of linear solenoid valves 31 to 36 for adjusting the pressure of a hydraulic oil pumped from an oil pump 28. The hydraulic oil is supplied to the friction elements 21 to 26.

As shown in FIG. 2, the solenoid valve 31 includes a sleeve 41, a spool 42 that functions as a valve body, a spring 43 that biases the spool 42 in one axial direction, a solenoid 44 configured to produce an electromagnetic force that attracts the spool 42 in the other axial direction, and a plunger 45 provided inside the solenoid 44.

The sleeve 41 has an input port 46, an output port 47, a drain port 48, and a feedback port 49. A part of the hydraulic oil output from the output port 47 flows into the feedback port 49. The hydraulic oil flowing into the feedback port 49 produces a feedback force according to the magnitude of the output hydraulic pressure.

The plunger 45 moves in the axial direction according to the magnitude of the excitation current of the solenoid 44. The spool 42 is movable in the axial direction together with the plunger 45 to change the degree of communication between the input port 46 and the output port 47 and the degree of communication between the output port 47 and the drain port 48. The spool 42 further includes an IN land 51 and an EX land 52. The IN land 51 opens and closes the input port 46. The EX land 52 opens and closes the drain port 48.

The stroke of the spool 42 (also referred to as stroke position) is determined based on a balance between the electromagnetic force of the solenoid 44, the biasing force of the spring 43, and a feedback force corresponding to the output hydraulic pressure of the working oil flowing into the feedback port 49. In this regard, the solenoid valve 31 includes a self-regulating pressure mechanism due to the feedback force.

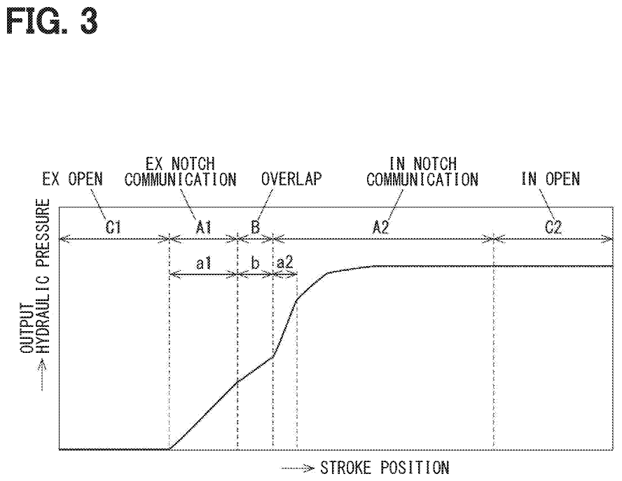

As shown in FIG. 3, the output hydraulic pressure changes according to the stroke of the spool 42. As shown in this relationship, the solenoid valve 31 has a characteristic including hydraulic pressure steep curve regions a1 and a2 as well as a hydraulic pressure gentle curve region b. The rate of change in the output hydraulic pressure with respect to the rate of change in stroke is relatively high in the steep curve regions a1, a2, and is relatively low in the gentle curve region b.

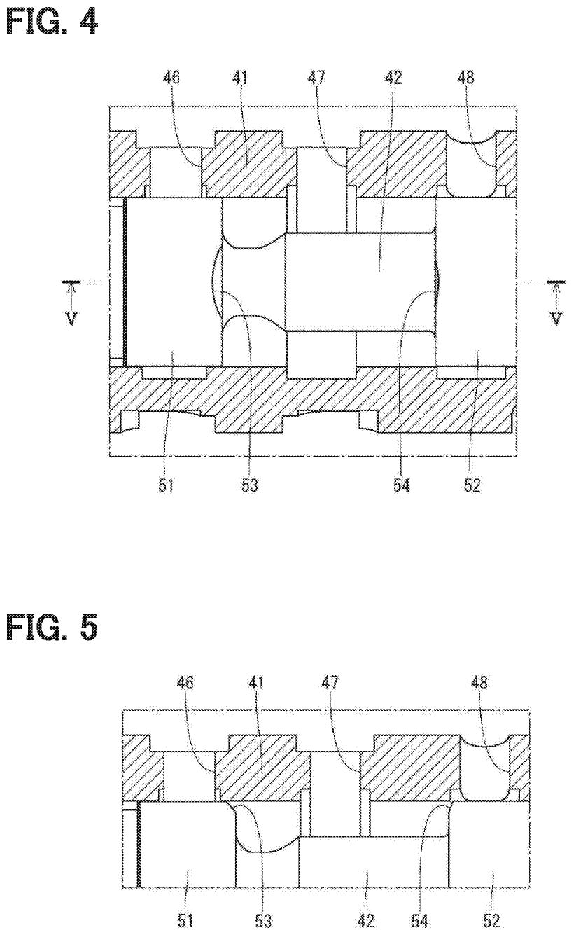

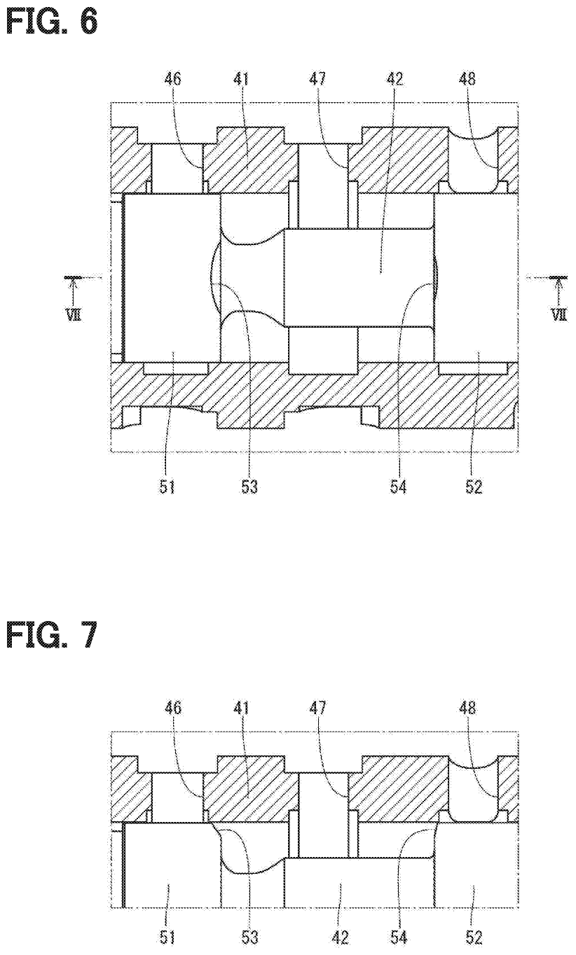

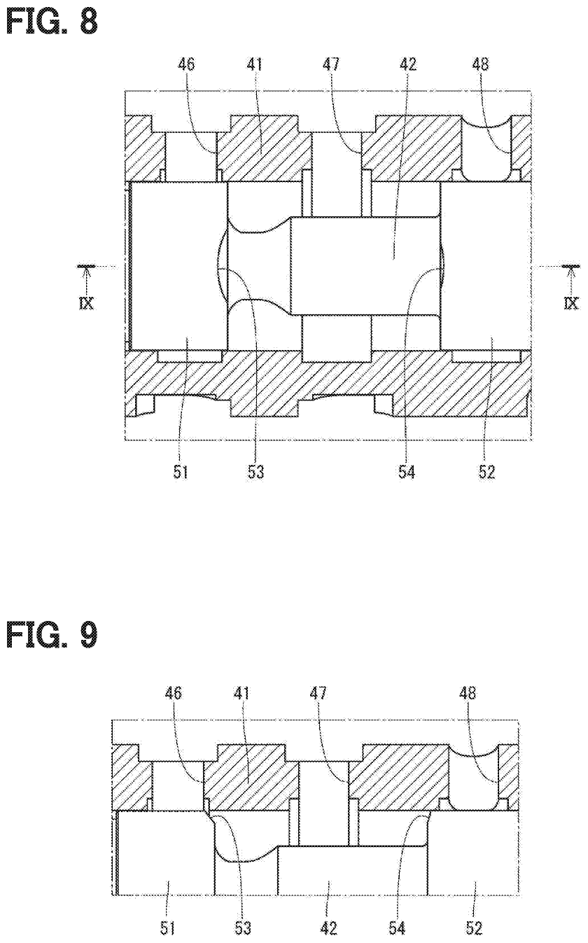

As shown in FIGS. 4 and 5, the hydraulic pressure steep curve region a1 in FIG. 3 is the entire stroke range corresponding to the state in which the drain port 48 is in communication with the output port 47 via only an EX notch 54 of the EX land 52 (also referred to as an EX notch communication range A1). As shown in FIGS. 6 and 7, the hydraulic pressure gentle curve region b in FIG. 3 is the entire stroke range corresponding to the state in which the closure of the input port 46 by the IN land 51 overlaps with the closure of the drain port 48 by the EX land 52 (also referred to as an overlap range B). As shown in FIGS. 8 and 9, the hydraulic pressure steep curve region a2 in FIG. 3 is a portion of the stroke range corresponding to the state in which the input port 46 is in communication with the output port 47 via only an IN notch 53 of the IN land 51 (also referred to as an IN notch communication range A2). Specifically, the hydraulic pressure steep curve region a2 corresponds to a portion of the IN notch communication range A2 which is directly adjacent to the overlap range B.

An EX opening range C1 of FIG. 3 is a stroke range corresponding to the state in which the drain port 48 is in communication with the output port 47 through the space between the EX land 52 and the IN land 51 rather than being in communication via only with the EX land 52. In addition, an IN opening range C2 of FIG. 3 is a stroke range corresponding to the state in which the input port 46 is in communication with the output port 47 through the space between the EX land 52 and the IN land 51 rather than being in communication via only with the IN land 51.

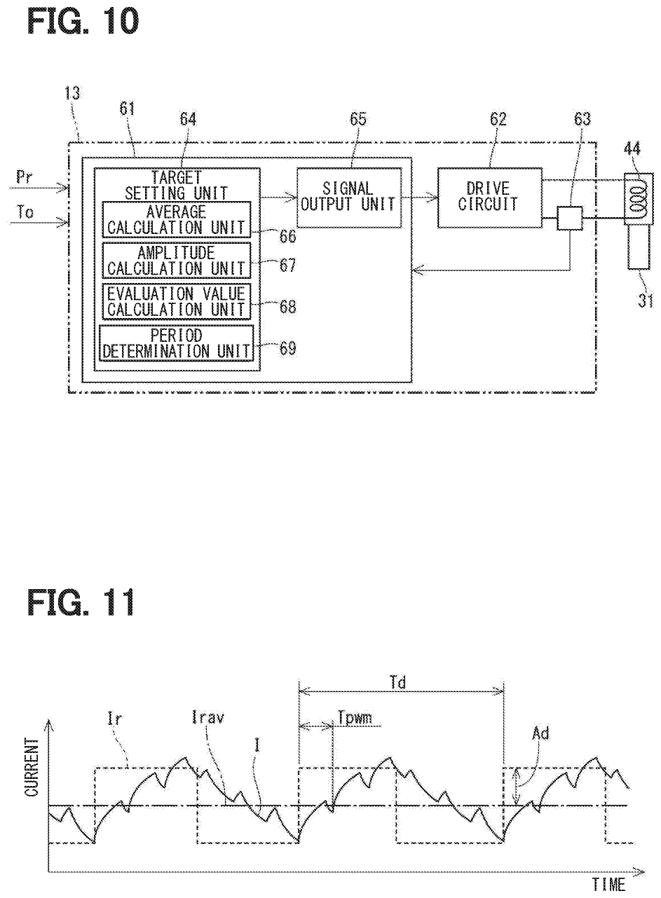

As shown in FIG. 10, the current controller 13 includes a microcontroller 61, a drive circuit 62 that functions as a drive unit, and a current detector 63 that detects the actual current of the solenoid 44. The microcontroller 61 is programmed to execute control processes based on the output values of the current detector 63 and other devices and sensors, which are not illustrated. The microcontroller 61 may be referred to as a processor. The microcontroller 61 includes a target setting unit 64 that sets a target current of the solenoid 44 according to a target output hydraulic pressure for the solenoid valves 31 to 36, and a signal output unit 65 that generates and outputs a drive signal based on the target current. The signal output unit 65 generates the drive signal so as to minimize the difference between the actual current and the target current of the solenoid 44. The drive circuit 62 energizes the solenoid 44 with a predetermined energization period according to the drive signal. In this way, the current controller 13 controls the current of the solenoid 44. The current detector 63 may be a current sensor that directly measures the actual current of the solenoid 44 or a different type of sensor that measures a value correlated with the actual current of the solenoid 44.

(Current Control)

Next, the current control by the current controller 13 will be described. The current controller 13 controls the current of the solenoid 44 with a pulse width modulation signal (PWM signal). As shown in FIG. 11, the operation of energizing and then de-energizing the solenoid 44 is repeated with a PWM period Tpwm, and the average value of the current I in the solenoid 44 is maintained near the average target current Irav. At this time, a dither amplitude Ad is added to the target current Ir so that the current I periodically changes with a dither period Td longer which is longer than the PWM period Tpwm. As a result, the spool 42 vibrates slightly and the spool 42 is maintained in a dynamic friction state.

When the current of the solenoid 44 is periodically changed with the dither period Td as described above, the occurrence of hysteresis due to the static friction of the spool 42 is reduced. On the other hand, the balance of the force on the spool 42 may be lost and the pulsation of the output hydraulic pressure may increase, which may lead to self-induced oscillation of the spool 42. The mechanism of occurrence of this phenomenon is as follows.

There are the following three prerequisites for the occurrence of self-induced oscillation.
<Precondition 1> The solenoid valve 31 has a self-regulating function due to a feedback force according to the output hydraulic pressure.
<Precondition 2> In order to ensure the linearity of the relationship between current and output hydraulic pressure, the solenoid valve 31 characteristic includes both a hydraulic pressure steep curve region and a hydraulic pressure gentle curve region. In the steep region, the degree of change in the output hydraulic pressure of the solenoid valve 31 with respect to the change in stroke is relatively steep. In contrast, in the gentle region, the degree of change in the output hydraulic pressure of the solenoid valve 31 with respect to the change in stroke is relatively gentle.
<Precondition 3> The dither amplitude Ad is applied to the target current Ir of the solenoid 44 such that the target current Ir of the solenoid 44 cyclically changes with the dither period Td which is longer than the energization switching period of the solenoid 44.

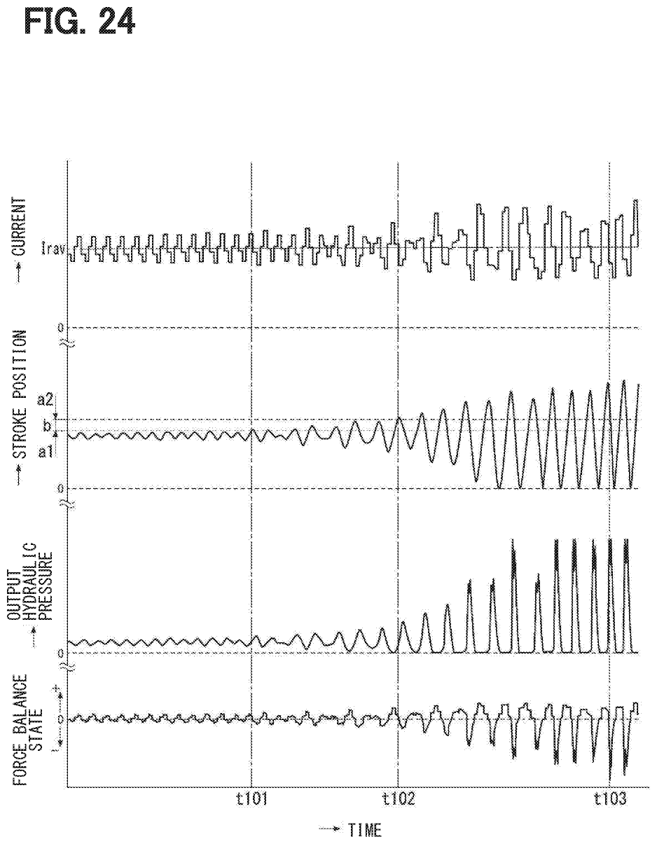

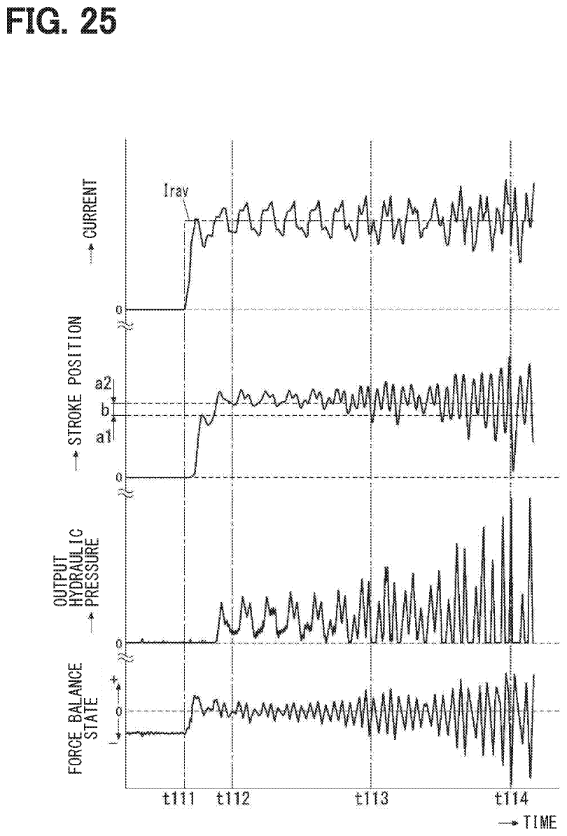

When the current control is performed under these prerequisite conditions, the pulse width of the output hydraulic pressure varies depending on the stroke of the spool 42 even if the same dither amplitude is applied to the target current. As a result, at time t101 in FIG. 24, the pulsation of the output hydraulic pressure changes when the stroke of the spool 42 transitions from the hydraulic pressure steep curve region a1 into the hydraulic pressure gentle curve region b. When the self-regulating pressure function occurs in response to this and the stroke return amount increases, the balance of the forces acting on the spool 42 is lost. From this state, at time t102 in FIG. 24, when the stroke position crosses the hydraulic pressure gentle curve region b and enters the hydraulic pressure steep curve region a2, the pulsation of the output hydraulic pressure changes again. When this is repeated, the rise of the output hydraulic pressure starts to be delayed, the balance of the forces is further disturbed, and the pulsation of the output hydraulic pressure increases. As a result, when the oscillation frequency of the spool 42 reaches the vicinity of resonance frequency around time t103 in FIG. 24, self-induced oscillation occurs and the spool 42 oscillates. The target setting unit 64 of the current controller 13 includes a functional unit for preventing the occurrence of such self-induced oscillation.

(Functional Units of Current Controller)

Next, the target setting unit 64 will be described with reference to FIG. 10. The target setting unit 64 applies the dither amplitude Ad to the target current Ir so that the target current Ir changes cyclically with a dither period Td longer than the energization switching period of the drive circuit 62 (that is, the PWM period Tpwm). Further, the target setting unit 64 sets the dither period Td of the target current Ir according to the positional relationship between a target stroke Sr and the hydraulic pressure gentle curve region b. The target stroke Sr is a stroke position of the spool 42 corresponding to the target output hydraulic pressure Pr. Specifically, the target setting unit 64 includes an average calculation unit 66, an amplitude calculation unit 67, an evaluation value calculation unit 68, and a period determination unit 69.

The average calculation unit 66 calculates the average target current Irav based on the target output hydraulic pressure Pr. In the first embodiment, the target output hydraulic pressure Pr is a value input from an external source. However, this is not intended to be limiting, and the target output hydraulic pressure Pr may be calculated by current controller 13 as well.

The amplitude calculation unit 67 calculates the dither amplitude Ad based on at least the average target current Irav. In the first embodiment, the amplitude calculation unit 67 calculates the dither amplitude Ad based on the average target current Irav and the oil temperature To of the hydraulic oil supplied to the solenoid valves 31 to 36.

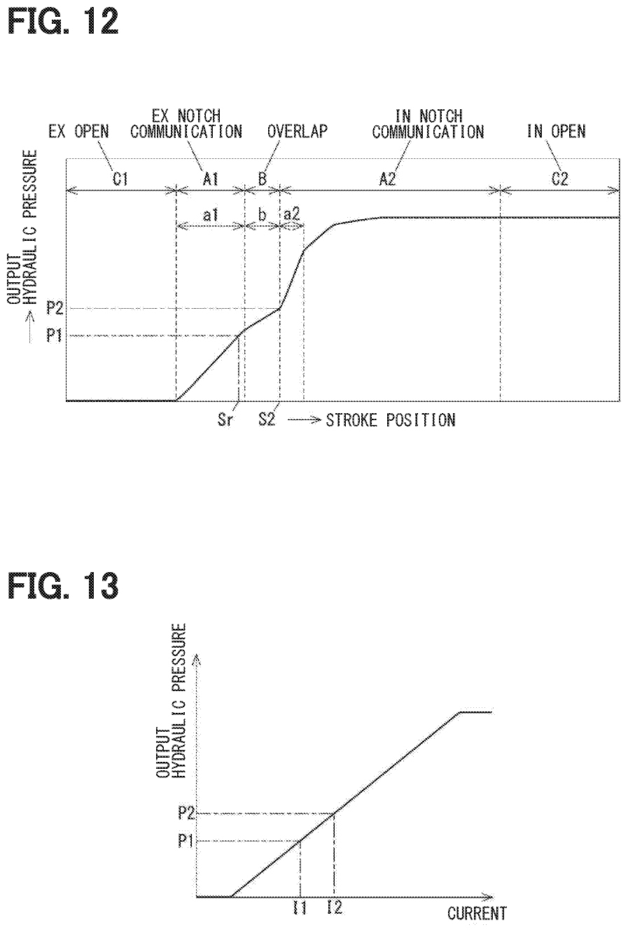

The evaluation value calculation unit 68 calculates an evaluation value Ve for determining the dither period Td based on the positional relationship between the target stroke Sr and the hydraulic pressure gentle curve region b. In the first embodiment, the evaluation value Ve is the difference in current between the target stroke Sr and the stroke position immediately before crossing over the hydraulic pressure gentle curve region b. Specifically, in FIG. 12, from the target stroke Sr, the stroke immediately before crossing over the hydraulic pressure gentle curve region b is S2. Then, the output hydraulic pressure P1 corresponding to the target stroke Sr and the output hydraulic pressure P2 corresponding to the stroke S2 are obtained from the stroke-output hydraulic pressure characteristic shown FIG. 12. Next, a current 11 corresponding to the output hydraulic pressure P1 and a current 12 corresponding to the output hydraulic pressure P2 are obtained from the current-output hydraulic pressure characteristic shown in FIG. 13. The evaluation value Ve is obtained by subtracting the current 11 from the current 12.

The period determination unit 69 compares the dither amplitude Ad with the evaluation value Ve. Then, when the dither amplitude Ad is smaller than the evaluation value Ve, a predetermined first period T1 is set as the dither period Td. On the other hand, when the dither amplitude Ad is equal to or larger than the evaluation value Ve, a predetermined second period T2, which is longer than the first period T1, is set as the dither period Td. The first period T1 and the second period T2 are set to values at which the dynamic friction state of the spool 42 is maintained, in order to prevent hysteresis caused by static friction of the spool 42.

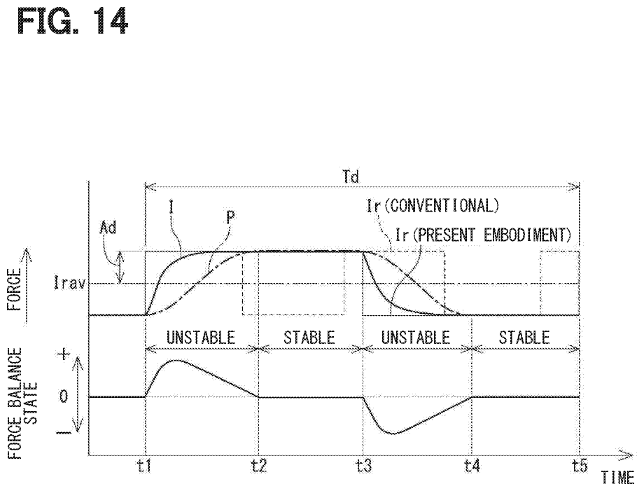

As described above, the target setting unit 64 calculates the evaluation value Ve based on the positional relationship between the target stroke Sr and the hydraulic pressure gentle curve region b, compares the evaluation value Ve with the dither amplitude Ad, and determines the dither period Td based on the comparison result. For example, when the dither amplitude Ad is equal to or larger than the evaluation value Ve, it is determined that the positional relationship between the target stroke Sr and the hydraulic pressure gentle curve region b is a positional relationship in which self-induced oscillation is likely to occur. In this case, the dither period Td is set to the relatively long second period T2 so that the oscillation frequency of the spool 42 moves away from the resonance frequency. By increasing the dither period Td in this way, even if the balance of forces is slightly disturbed and the balance state becomes unstable as shown at time t1 to t2 and time t3 to t4 in FIG. 14, it is possible to provide stable time periods to bring balance to the force. In this example, stable states are provided at time t2 to t3 and time t4 to t5 in FIG. 14.

Each of the functional units 64 to 69 included in the current controller 13 may be realized by hardware processing performed by a dedicated logic circuit, may be realized by software processing by executing a program stored in advance in a memory such as a computer-readable non-transitory tangible recording medium or the like by a CPU, or may be realized by a combination of the hardware processing and the software processing. Any of the functional units 64 to 69 may be implemented by hardware processing and/or software processing, and can be appropriately selected based on design.

(Current Controller Processing)

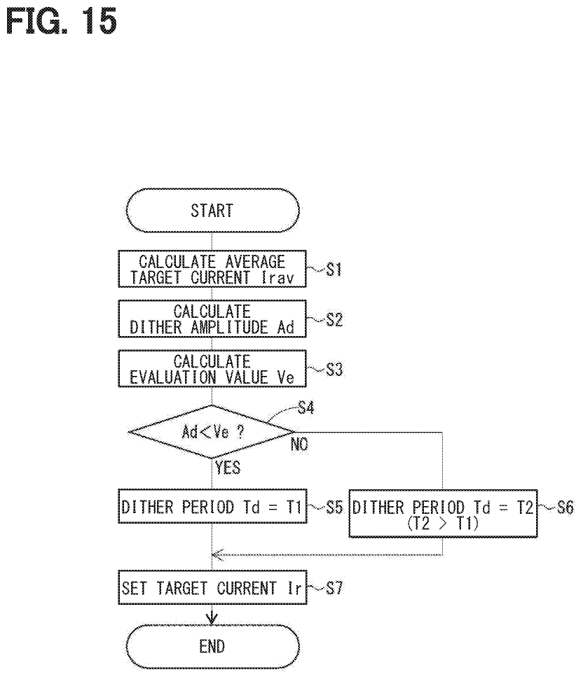

Next, a process executed by the current controller 13 for setting the target current will be described with reference to FIG. 15. The routine shown in FIG. 15 is repeatedly executed while the current controller 13 is in operation. Hereinafter, “S” means step.

In S1 of FIG. 15, the average target current Irav is calculated. After S1, the processing proceeds to S2.

In S2, the dither amplitude Ad is calculated based on the average target current Irav and the oil temperature To. After S2, the processing proceeds to S3.

In S3, the evaluation value Ve for determining the dither period Td is calculated based on the positional relationship between the target stroke Sr and the hydraulic pressure gentle curve region b. After S3, the processing proceeds to S4.

In S4, it is determined whether the dither amplitude Ad is smaller than the evaluation value Ve. If the dither amplitude Ad is smaller than the evaluation value Ve (S4: YES), the processing proceeds to S5. If the dither amplitude Ad is equal to or larger than the evaluation value Ve (S4: NO), the processing proceeds to S6.

In S5, the predetermined first period T1 is set as the dither period Td. After S5, the processing proceeds to S7.

In S6, the predetermined second period T2, which is longer than the first period T1, is set as the dither period Td. After S6, the processing proceeds to S7.

In S7, the target current Ir is set based on the average target current Irav, the dither amplitude Ad, and the dither period Td. After S7, the process exits the routine of FIG. 15.

Next, chances in various values (i.e., current, stroke, output hydraulic pressure, and force balance) while the current controller 13 executes the current control process will be shown by comparison with a comparative example. FIG. 25 is a time chart showing changes in the various values in the comparative example in which the dither period is set to a constant value without considering the positional relationship between the target stroke and the hydraulic pressure gentle curve region. In FIG. 25, after the average target current Irav is changed at time t111, the current changes so as to follow the average target current Irav. Thereafter, at time t112, the stroke begins to enter into the hydraulic pressure gentle curve region b from the hydraulic pressure steep curve region a2, and at time t113, the stroke begins to cross through the hydraulic pressure gentle curve region b entirely. Along with this, the pulsation of the output hydraulic pressure increases. During this period, the current is constantly oscillating. As a result, there is no time for the force balance to stabilize, and as such the force balance state is unstable. Then, when the oscillation frequency of the stroke reaches the vicinity of the resonance frequency around time t114, self-induced oscillation occurs and oscillation occurs.

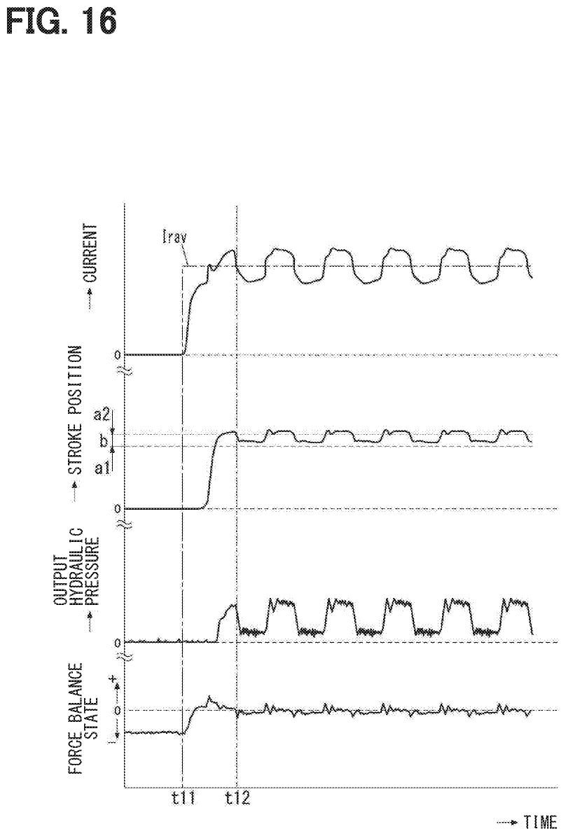

In contrast, FIG. 16 shows the changes in the various values according to the first embodiment. Here, after the average target current Irav is changed at time t11, the current changes so as to follow the average target current Irav. After that, at time t12, the stroke enters the hydraulic pressure gentle curve region b from the hydraulic pressure steel curve region a2, and the balance of the force is slightly disturbed. As a result, the balance state is unstable. However, since the dither period Td is set to be relatively long and a period of time is provided for the balance of forces to be restored, the force balance is not further disturbed and the stable state is immediately returned.

(Effects)

As described above, in the first embodiment, the current controller 13 is applied to the solenoid valves 31 to 36 which include a self-regulating pressure function due to the feedback force from the output hydraulic pressure and which have a characteristic that includes both hydraulic pressure steep curve regions a1, a2 and a hydraulic pressure gentle curve region b. In the steep regions, the degree of change in the output hydraulic pressure with respect to the change in stroke of the spool 42 is relatively steep. In contrast, in the gentle region, the degree of change in the output hydraulic pressure with respect to the change in stroke of the spool 42 is relatively gentle.

The current controller 13 includes the drive circuit 62 that energizes the solenoid 44 with a predetermined energization period according to a drive signal, the signal output unit 65 that generates and outputs the drive signal based on the target current Ir for the solenoid 44, and the target setting unit 64 that applies a dither amplitude Ad to vary the target current Ir periodically with a dither period Td that is longer than the energization period of the drive circuit 62. The target setting unit 64 sets the target current Ir according to the positional relationship between the target stroke Sr and the hydraulic pressure gentle curve region b.

As a result, if this positional relationship is such that self-induced oscillation is likely to occur, it is possible to set the target current Ir at which the force balance is not greatly disturbed. Therefore, it is possible to prevent the occurrence of self-induced oscillation in the solenoid valves.

Further, in the first embodiment, the target setting unit 64 determines the dither period Td according to the positional relationship between a target stroke Sr and the hydraulic pressure gentle curve region b. Due to this, if the positional relationship is such that the occurrence of self-induced oscillation is likely, by setting the target current such that the oscillation frequency of the spool 42 changes away from the resonance frequency, the occurrence of self-induced oscillation can be prevented.

Further, in the first embodiment, the target setting unit 64 includes an average calculation unit 66, an amplitude calculation unit 67, an evaluation value calculation unit 68, and a period determination unit 69. The average calculation unit 66 calculates the average target current Irav based on the target output hydraulic pressure Pr. The amplitude calculation unit 67 calculates the dither amplitude Ad based on the average target current Irav. The evaluation value calculation unit 68 calculates an evaluation value Ve for determining the dither period Td based on the positional relationship between the target stroke Sr and the hydraulic pressure gentle curve region b. When the dither amplitude Ad is smaller than the evaluation value Ve, the period determination unit 69 sets the predetermined first period T1 as the dither period Td. On the other hand, when the dither amplitude Ad is equal to or larger than the evaluation value Ve, a predetermined second period T2, which is longer than the first period T1, is set as the dither period Td.

Due to this, if the positional relationship is such that the occurrence of self-induced oscillation is likely, i.e., if the dither amplitude Ad is equal to or greater than the evaluation value Ve, by setting the dither period Td to be longer, the oscillation frequency of the spool 42 changes away from the resonance frequency. By increasing the dither period Td in this way, even if the balance of forces on the spool 42 is slightly disturbed and the balance state becomes unstable, it is possible to provide stable time periods to bring balance to the force. Therefore, it is possible to prevent the occurrence of self-induced oscillation in the solenoid valves.

### Second Embodiment

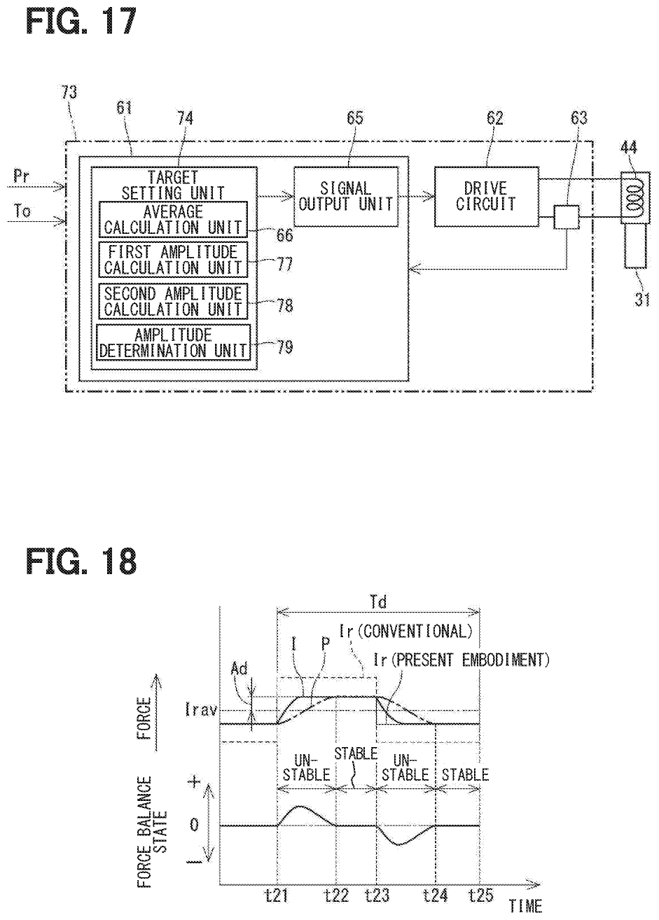

In the second embodiment, as shown in FIG. 17, a target setting unit 74 of a current controller 73 sets a dither amplitude Ad of the target current Ir according to the positional relationship between a target stroke Sr and the hydraulic pressure gentle curve region b. Specifically, the target setting unit 74 includes an average calculation unit 66, a first amplitude calculation unit 77, a second amplitude calculation unit 78, and an amplitude determination unit 79.

The first amplitude calculation unit 77 calculates a first dither amplitude based on at least the average target current Irav. The first dither amplitude is a first provisional value of the dither amplitude Ad. In the second embodiment, the first amplitude calculation unit 77 calculates the first dither amplitude Ad1 based on the average target current Irav and the oil temperature To.

The second amplitude calculation unit 78 calculates a second dither amplitude Ad2 based on the positional relationship between the target stroke Sr and the hydraulic pressure gentler curve region b. The second dither amplitude Ad2 is a second provisional value of the dither amplitude Ad. In the second embodiment, the second dither amplitude Ad2 is, similar to the evaluation value Ve in the first embodiment, the difference in current between the target stroke Sr and the stroke position immediately before crossing over the hydraulic pressure gentle curve region b.

The amplitude determination unit 79 compares the first dither amplitude Ad1 and the second dither amplitude Ad2. Then, when the first dither amplitude Ad1 is smaller than the second dither amplitude Ad2, the first dither amplitude Ad1 is set as the dither amplitude Ad. On the other hand, when the first dither amplitude Ad1 is equal to or greater than the second dither amplitude Ad2, the second dither amplitude Ad2 is set as the dither amplitude Ad. In the second embodiment, the dither period Td is set to a predetermined value.

As described above, the target setting unit 74 calculates the second dither amplitude Ad2 based on the positional relationship between the target stroke Sr and the hydraulic pressure gentle curve region b, compares the first dither amplitude Ad1 to the second dither amplitude Ad2, and determines the dither amplitude Ad based on the comparison result. For example, when the first dither amplitude Ad1 is equal to or larger than the second dither amplitude Ad2, it is determined that the positional relationship between the target stroke Sr and the hydraulic pressure gentle curve region b is a positional relationship in which self-induced oscillation is likely to occur. Then, the dither amplitude Ad is set to the second dither amplitude Ad2 which is relatively low so that the stroke of the spool 42 does not cross through the hydraulic pressure gently curve region b. By decreasing the second dither amplitude Ad2 in this way, even if the balance of forces is slightly disturbed and the balance state becomes unstable as shown at time t21 to t22 and time t23 to t24 in FIG. 18, the balance of forces returns immediately so the amount of time spent in the unable state is short. In this example, stable states are provided at time t22 to t23 and time t24 to t25 in FIG. 18.

(Current Controller Processing)

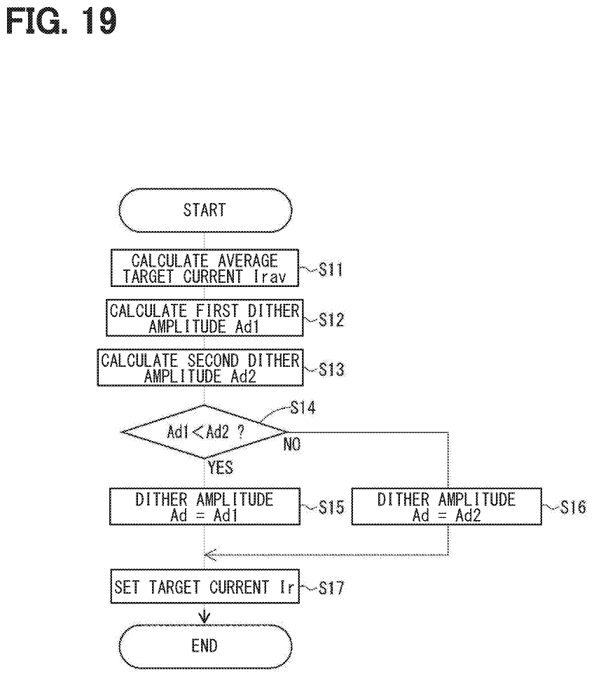

Next, a process executed by the current controller 73 for setting the target current will be described with reference to FIG. 19. The routine shown in FIG. 19 is repeatedly executed while the current controller 73 is in operation.

In S11 of FIG. 19, the same processing as S1 of FIG. 15 of the first embodiment is performed. After S11, the processing proceeds to S12.

In S12, the first dither amplitude Ad1 is calculated based on the average target current Irav and the oil temperature To. After S12, the processing proceeds to S13.

In S13, the second dither amplitude Ad2 is calculated based on the positional relationship between the target stroke Sr and the hydraulic pressure gentler curve region b. The second dither amplitude Ad2 is a second provisional value of the dither amplitude Ad. After S13, the processing proceeds to S14.

In S14, it is determined whether the first dither amplitude Ad1 is smaller than the second dither amplitude Ad2. If the first dither amplitude Ad1 is smaller than the second dither amplitude Ad2 (S14: YES), the processing proceeds to S15. If the first dither amplitude Ad1 is greater than or equal to the second dither amplitude Ad2 (S14: NO), the processing proceeds to S16.

In S15, the first dither amplitude Ad1 is set as the dither amplitude Ad. After S15, the processing proceeds to S17.

In S16, the second dither amplitude Ad2 is set as the dither amplitude Ad. After S16, the processing proceeds to S17.

In S17, the target current Ir is set based on the average target current Irav, the dither amplitude Ad, and the dither period Td. After S17, the processing exits the routine of FIG.19.

Next, chances in various values (i.e., current, stroke, output hydraulic pressure, and force balance) while the current controller 73 executes the current control process will be shown by comparison with a comparative example. As discussed previously, in the comparative example shown in FIG. 25, the current is constantly oscillating. As a result, there is no time for the force balance to stabilize, and as such the force balance state is unstable. Then, when the oscillation frequency of the stroke reaches the vicinity of the resonance frequency around time t114, self-induced oscillation occurs and oscillation occurs.

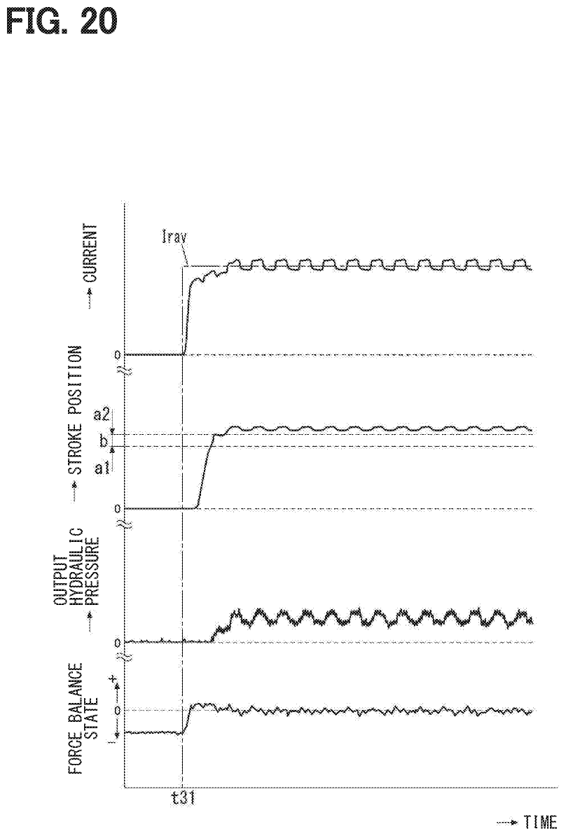

In contrast, FIG. 20 shows the changes in the various values according to the second embodiment. Here, after the average target current Irav is changed at time t131, the current changes so as to follow the average target current Irav. Then, after the current catches up with the average target current Irav, the stroke does not further transition from the hydraulic pressure steep curve region a2 to the hydraulic pressure gentle curve region b. Therefore, there is no large disturbance to the balance of force, and a stable region can be ensured.

(Effects)

As described above, in the second embodiment, the target setting unit 74 sets the target current Ir according to the positional relationship between the target stroke Sr and the hydraulic pressure gentle curve region b. Therefore, similar to the first embodiment, it is possible to prevent the occurrence of self-induced oscillation in the solenoid valves.

Further, in the second embodiment, the target setting unit 74 determines the dither amplitude Ad according to the positional relationship between a target stroke Sr and the hydraulic pressure gentle curve region b. Due to this, if the positional relationship is such that the occurrence of self-induced oscillation is likely, by setting the target current Ir such that the stroke of the spool 42 does not cross through the hydraulic pressure gentle curve region b, the occurrence of self-induced oscillation can be prevented.

Further, in the second embodiment, the target setting unit 74 includes the average calculation unit 66, the first amplitude calculation unit 77, the second amplitude calculation unit 78, and the amplitude determination unit 79. The first amplitude calculation unit 77 calculates the first dither amplitude based on the average target current Irav. The first dither amplitude is a first provisional value of the dither amplitude Ad. The second amplitude calculation unit 78 calculates a second dither amplitude Ad2 based on the positional relationship between the target stroke Sr and the hydraulic pressure gentler curve region b. The second dither amplitude Ad2 is a second provisional value of the dither amplitude Ad. When the first dither amplitude Ad1 is smaller than the second dither amplitude Ad2, the first dither amplitude Ad1 is set as the dither amplitude Ad by the amplitude determination unit 79. On the other hand, when the first dither amplitude Ad1 is equal to or greater than the second dither amplitude Ad2, the second dither amplitude Ad2 is set as the dither amplitude Ad.

Due to this, if the positional relationship is such that the occurrence of self-induced oscillation is likely, i.e., if the first dither amplitude Ad1 is equal to or greater than the second dither amplitude Ad2, the dither amplitude is set to be relatively low such that the stroke does not cross through the hydraulic pressure gentle curve region b. By reducing the dither amplitude Ad in this way, the balance of the force on the spool 42 is not greatly disturbed. Therefore, it is possible to prevent the occurrence of self-induced oscillation in the solenoid valves.

### Third Embodiment

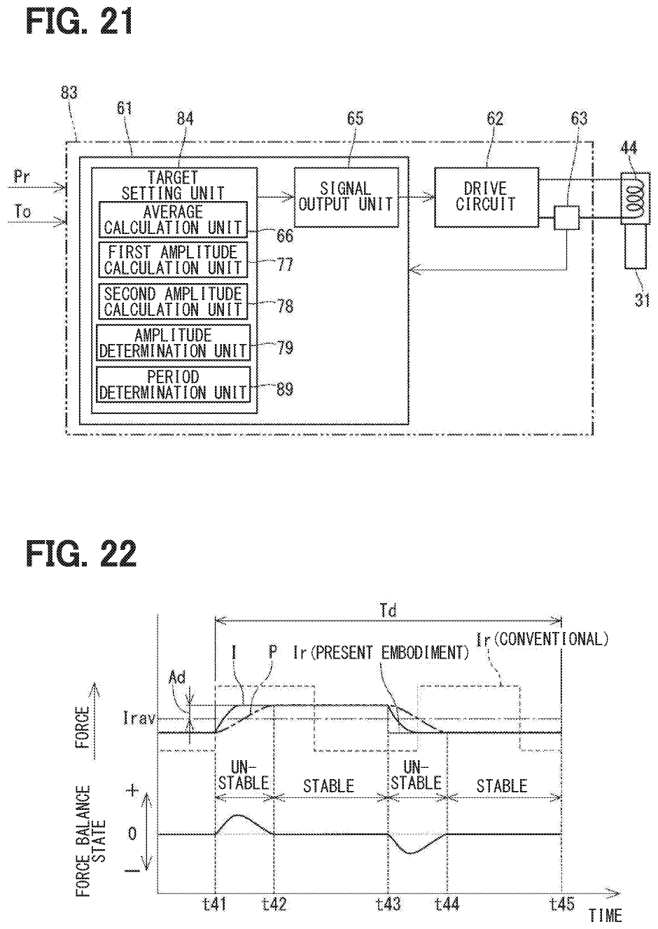

In the third embodiment, as shown in FIG. 21, a target setting unit 84 of a current controller 83 sets a dither period Td and a dither amplitude Ad of the target current Ir according to the positional relationship between a target stroke Sr and the hydraulic pressure gentle curve region b. Specifically, the target setting unit 84 includes an average calculation unit 66, a first amplitude calculation unit 77, a second amplitude calculation unit 78, an amplitude determination unit 79, and a period determination unit 89.

The period determination unit 89 compares the first dither amplitude Ad1 and the second dither amplitude Ad2. Then, when the first dither amplitude Ad1 is smaller than the second dither amplitude Ad2, a predetermined first period T1 is set as the dither period Td. On the other hand, when the first dither amplitude Ad1 is equal to or larger than the second dither amplitude Ad2, a predetermined second period T2, which is longer than the first period T1, is set as the dither period Td.

As described above, the target setting unit 74 calculates the second dither amplitude Ad2 based on the positional relationship between the target stroke Sr and the hydraulic pressure gentle curve region b, compares the first dither amplitude Ad1 to the second dither amplitude Ad2, and determines the dither amplitude Ad and the dither period Td based on the comparison result. For example, when the first dither amplitude Ad1 is equal to or larger than the second dither amplitude Ad2, it is determined that the positional relationship between the target stroke Sr and the hydraulic pressure gentle curve region b is a positional relationship in which self-induced oscillation is likely to occur. Then, the dither amplitude Ad is set to the second dither amplitude Ad2 which is relatively low so that the stroke of the spool 42 does not cross through the hydraulic pressure gently curve region b, and also the dither period Td is set to the relatively long second period T2 so that the oscillation frequency of the spool 42 moves away from the resonance frequency. By decreasing the second dither amplitude Ad2 and increasing the dither period Td in this way, even if the balance of forces is slightly disturbed and the balance state becomes unstable as shown at time t41 to t42 and time t43 to t44 in FIG. 22, it is possible to provide stable time periods to bring balance to the force and also ensure that the force balance returns immediately. In this example, stable states are provided at time t42 to t43 and time t44 to t45 in FIG. 22.

(Current Controller Processing)

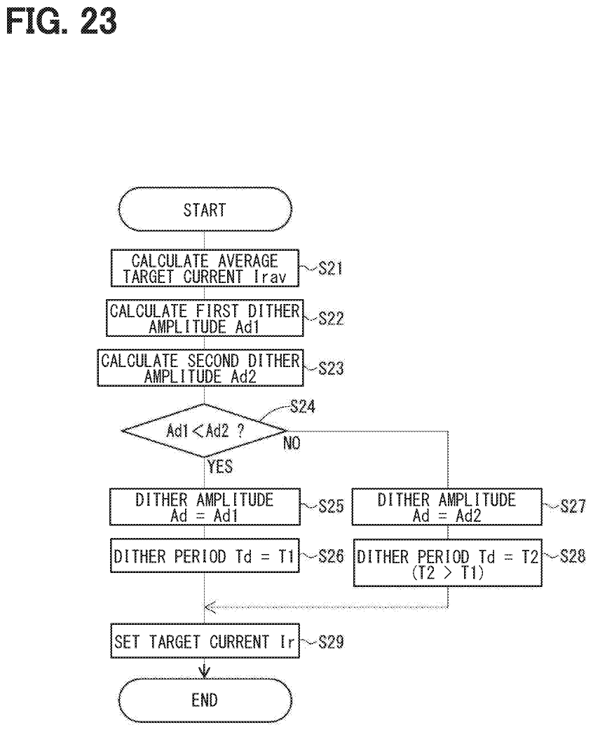

Next, a process executed by the current controller 83 for setting the target current will be described with reference to FIG. 23. The routine shown in FIG. 23 is repeatedly executed while the current controller 83 is in operation.

In S21 to S25 and S27 of FIG. 22, the same processes as S11 to S16 of FIG. 19 of the second embodiment are performed.

In S26 which is after S25, the predetermined first period T1 is set as the dither period Td. After S26, the processing proceeds to S29.

In S28 which is after S27, the predetermined second period T2, which is longer than the first period T1, is set as the dither period Td. After S28, the processing proceeds to S29.

In S29, the target current Ir is set based on the average target current Irav, the dither amplitude Ad, and the dither period Td. After S29, the processing exits the routine of FIG. 23.

(Effects)

As described above, in the third embodiment, the target setting unit 84 sets the target current Ir according to the positional relationship between the target stroke Sr and the hydraulic pressure gentle curve region b. Therefore, similar to the first and second embodiments, it is possible to prevent the occurrence of self-induced oscillation in the solenoid valves.

Further, in the third embodiment, the target setting unit 84 sets the dither period Td and the dither amplitude Ad of the target current Ir according to the positional relationship between a target stroke Sr and the hydraulic pressure gentle curve region b. Due to this, if the positional relationship is such that the occurrence of self-induced oscillation is likely, by setting the target current Ir such that the stroke of the spool 42 does not cross through the hydraulic pressure gentle curve region b, and also setting the target current such that the oscillation frequency of the spool 42 changes away from the resonance frequency, the occurrence of self-induced oscillation can be prevented to a greater degree as when compared to the first and second embodiments.

### Other Embodiments

The solenoid valve and the current controller may be collectively referred to as a hydraulic system.

In another embodiment, the target setting unit determines whether or not self-induced oscillation may occur based on whether or not the distance between the target stroke and the hydraulic pressure gentle curve region is equal to or less than a threshold value, and set the dither period or the dither amplitude to be smaller if this distance is equal to or less than the threshold value as compared to otherwise.

In another embodiment, the current control of the solenoid is not limited to the PWM control, and may be another dither chopper control. In another embodiment, the self-regulating pressure function from the feedback force of the output hydraulic pressure is implemented by detecting the magnitude of the output hydraulic pressure and applying a force corresponding to the detected value to the spool by using, for example, electromagnetic force.

The control circuit and method described in the present disclosure may be implemented by a special purpose computer which is configured with a memory and a processor programmed to execute one or more particular functions embodied in computer programs of the memory. Alternatively, the control circuit described in the present disclosure and the method thereof may be realized by a dedicated computer configured as a processor with one or more dedicated hardware logic circuits. Alternatively, the control circuit and method described in the present disclosure may be realized by one or more dedicated computer, which is configured as a combination of a processor and a memory, which are programmed to perform one or more functions, and a processor which is configured with one or more hardware logic circuits. The computer programs may be stored, as instructions to be executed by a computer, in a tangible non-transitory computer-readable medium.

The present disclosure has been described based on the embodiments. However, the present disclosure is not limited to the embodiments and structures. This disclosure also encompasses various modifications and variations within the scope of equivalents. Furthermore, various combination and formation, and other combination and formation including one, more than one or less than one element may be made in the present disclosure.

1. A current controller for controlling a current of a solenoid, the current controller being applied to a solenoid valve that has a self-regulating pressure function due to a feedback force from output hydraulic pressure and which has a characteristic that includes a hydraulic pressure steep curve region and a hydraulic pressure gentle curve region, a degree of change in the output hydraulic pressure with respect to a change in stroke of a valve body being relatively steep in the hydraulic pressure steep curve region and relatively gentle in the hydraulic pressure gentle curve region, the current controller comprising:
a drive unit configured to energize the solenoid with a predetermined energization period according to a drive signal;
a signal output unit configured to generate and output the drive signal based on a target current for the solenoid; and
a target setting unit that applies a dither amplitude to the target current such that the target current changes periodically with a dither period longer than the energization period, wherein
a target stroke is defined as the stroke of the valve element corresponding to a target output hydraulic pressure, and
the target setting unit is configured to set the target current according to a positional relationship between the target stroke and the hydraulic pressure gentle curve region.

2. The current controller according to claim 1, wherein the target setting unit is configured to determine the dither period according to the positional relationship between the target stroke and the hydraulic pressure gentle curve region.

3. The current controller according to claim 2, wherein
the target setting unit includes
an average calculation unit that calculates an average target current based on the target output hydraulic pressure,
an amplitude calculation unit that calculates the dither amplitude based on the average target current,
an evaluation value calculation unit that calculates an evaluation value for determining the dither period based on the positional relationship between the target stroke and the hydraulic pressure gentle curve region, and
a period determination unit that sets a predetermined first period as the dither period when the dither amplitude is smaller than the evaluation value, and sets a predetermined second period as the dither period when the dither amplitude is equal to or greater than the evaluation value, the second period being longer than the first period.

4. The current controller according to claim 1, wherein the target setting unit is configured to determine the dither amplitude according to the positional relationship between the target stroke and the hydraulic pressure gentle curve region.

5. The current controller according to claim 4, wherein
the target setting unit includes
an average calculation unit that calculates an average target current based on the target output hydraulic pressure,
a first amplitude calculation unit that calculates a first dither amplitude based on the average target current, the first dither amplitude being a first provisional value of the dither amplitude,
a second amplitude calculation unit that calculates a second dither amplitude based on the positional relationship between the target stroke and the hydraulic pressure gentler curve region, the second dither amplitude being a second provisional value of the dither amplitude, and
an amplitude determination unit that sets the first dither amplitude as the dither amplitude when the first dither amplitude is smaller than the second dither amplitude, and sets the second dither amplitude as the dither amplitude when the first dither amplitude is equal to or greater than the second dither amplitude.

6. The current controller according to claim 5, wherein the target setting unit includes a period determination unit that sets a predetermined first period as the dither period when the first dither amplitude is smaller than the second dither amplitude, and sets a predetermined second period as the dither period when the first dither amplitude is equal to or greater than the second dither amplitude, the second period being longer than the first period.

7. A hydraulic system, comprising:
a solenoid valve including
a sleeve including a plurality of ports,
a spool disposed in the sleeve and configured to be movable across a stroke range to selectively open or close the plurality of ports to vary an output hydraulic pressure of the solenoid valve, and
a solenoid that when energized causes the spool to move within the stroke range, the stroke range including a hydraulic pressure steep curve region and a hydraulic pressure gentle curve region, a degree of change in the output hydraulic pressure with respect to a change in stroke of the spool being higher in the hydraulic pressure steep curve region as compared to the hydraulic pressure gentle curve region;
a drive circuit configured to energize the solenoid with a predetermined energization period according to a drive signal; and
a processor coupled to the drive circuit, the processor being programmed to:
generate and output the drive signal based on a target current for the solenoid, the target current having applied thereto a dither amplitude such that the target current changes periodically with a dither period longer than the energization period, and
set the target current according to a positional relationship between a target stroke and the hydraulic pressure gentle curve region, the target stroke being the stroke of the spool corresponding to a target output hydraulic pressure.
